(19) United States
(12) Patent Application Publication
(10) Pub. No.: US 2015/0227226 A1
(43) Pub. Date: Aug. 13, 2015

(54) Screen Protector

(71) Applicant: Griffin Technology, Inc., Nashville, TN (US)

(72) Inventors: Aaron Wierenga, Nashville, TN (US); Evan Reese, Nashville, TN (US)

(73) Assignee: Griffin Technology, Inc., Nashville, TN (US)

(21) Appl. No.: 14/620,489

(22) Filed: Feb. 12, 2015

Related U.S. Application Data
(60) Provisional application No. 61/939,003, filed on Feb. 12, 2014.

(51) Int. Cl. G06F 3/041; G09G 5/00

(52) U.S. Cl. CPC G06F 3/041; G09G 5/006; G09G 2300/04

(57) ABSTRACT

A protective cover for a device having a touchscreen and a fingerprint sensor includes a Polyethylene terephthalate touchscreen cover that covers the touchscreen while allowing the touchscreen to be used. A die cut opening in the touchscreen cover corresponds to a location of the fingerprint sensor and a flexible membrane covers the opening. The flexible membrane is preferably constructed from Thermoplastic polyurethane that is bonded to the touchscreen cover. The touchscreen cover is then glued to an injected polycarbonate plastic rigid frame to for the front of a protective device case assembly.

### CROSS-REFERENCES TO RELATED APPLICATIONS

The present Utility Patent Application is based upon and claims priority from co-pending U.S. Provisional Patent Application No. 61/939,003 filed Feb. 12, 2014 entitled “Screen Protector”.

### STATEMENT REGARDING FEDERALLY SPONSORED RESEARCH OR DEVELOP ENT

Not. Applicable

### REFERENCE TO SEQUENCE LISTING OR COMPUTER PROGRAM LISTING APPENDIX

Not Applicable

### BACKGROUND OF THE INVENTION

Fingerprint identification sensors that can detect and identify human fingerprints are increasingly used to secure computers, mobile phones and sensitive facilities. In order to identify a fingerprint, these sensors must be able to detect the ridges and features present on a finger that are unique to that finger. Unfortunately, these fingerprint sensors typically cannot be accessed when the device with the sensor is secured within a protective case. Protective touchscreen covers have been developed that allow a touchscreen to be used when it is beneath the protective cover. Unfortunately, a fingerprint sensor cannot read a fingerprint through existing touch screen covers. Therefore, what is needed is a way to use existing devices with fingerprint identification sensors while the devices are secured within a protective case.

### BRIEF SUMMARY OF THE INVENTION

An embodiment of the present invention is directed toward a protective cover for a device having a touchscreen and a fingerprint sensor. The protective cover includes a Polyethylene terephthalate touchscreen cover that covers the touchscreen while allowing the touchscreen to be accessed and used. The touchscreen cover includes an opening that corresponds to the location of the fingerprint sensor on the device when the protective cover is installed over the device. A flexible Thermoplastic polyurethane membrane covers the opening in the touchscreen cover. The flexible membrane is preferably bonded to the touchscreen cover to secure it. The flexible membrane is also preferably provided with a matte textured surface that keeps the membrane from clinging to the sensor and has a pleasing appearance. The touchscreen cover is glued to a rigid frame to produce a protective cover which forms part of it larger device case.

The provision of flexible membrane over the fingerprint sensor allows the fingerprint sensor to be used while the device is contained within the case and thus, is a substantial improvement upon the prior art.

### BRIEF DESCRIPTION OF THE SEVERAL VIEWS OF THE DRAWINGS

FIG. 1 is an illustration of a protective device cover constructed in accordance with an embodiment of the present invention.

### DETAILED DESCRIPTION OF THE INVENTION

The present invention is directed toward a protective cover construction for an electronic device that includes a touchscreen and a fingerprint identification sensor. The protective cover utilizes a flexible, non-stick membrane material such as Thermoplastic polyurethane (TPU) through which the fingerprint scanner can read fingerprints. This membrane material is bonded to a die cut Polyethylene terephthalate (PET) plastic substrate touchscreen cover that is glued to a rigid injected polycarbonate plastic frame. An opening is cut in the touchscreen cover that roughly corresponds to the size and location of the fingerprint sensor. The flexible membrane material is then bonded over the opening in the relatively rigid touch screen cover.

The above described assembly is used as a protective screen cover for a device case for a touch screen device that allows for the use of fingerprint identification sensor through the protective cover. The protective screen cover assembly of Thermoplastic polyurethane flexible membrane, die cut Polyethylene terephthalate substrate, and rigid polycarbonate plastic frame is combined with a device case assembly made up of a silicone shell, rigid polycarbonate plastic shell, polyurethane foam, and silicone camera plug to form the completed device case.

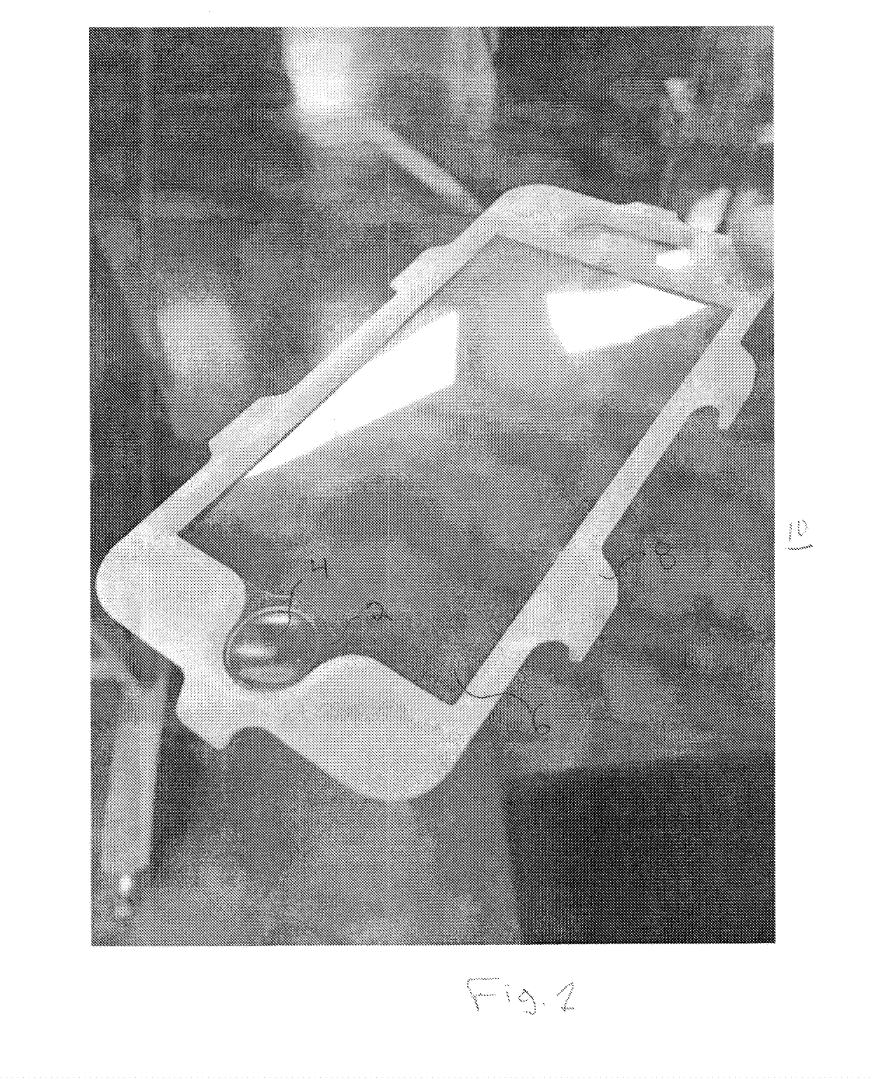

Referring now to FIG. 1, an illustration of a protective device cover 10 constructed in accordance with the present invention is shown. The device cover 10 includes a touchscreen cover 6 that is glued on a rigid plastic frame 8. A hole has been cut in the touchscreen cover that corresponds with the position of the fingerprint sensor when the protective device cover 10 is positioned over the front of the touchscreen device. A flexible membrane 2 with enough flexibility to allow the fingerprint sensor to properly function is the bonded to the cover 6 over the opening 4. In the embodiment shown the entire assembly 10 is then mounted over the device, onto a back cover for the device to form the device case. While the protective cover 10 shown in is for an iPhone® case, those skilled in the art will appreciate that the present invention can be readily adapted to any device case for a device having a fingerprint sensor.

The above described screen protector allows a user to use the touch screen of a device as well as its fingerprint sensor while the device is enclosed in a protective case and, therefore, represents a substantial improvement upon the prior art. Although there have been described particular embodiments of the present invention of a new and useful screen protector, those skilled in the art will appreciate that the screen protector can be incorporated into a wide variety of protective cases. Therefore, it is not intended that the particular embodiments described be construed as limitations upon the scope of this invention except as set forth in the following claims.

What is claimed is:

1. A protective cover for a device having a touchscreen and a fingerprint sensor, said protective cover comprising:
a touchscreen cover that covers said touchscreen while allowing said touchscreen to be used;
an opening in said touchscreen cover that corresponds to a location of said fingerprint sensor when said protective cover is installed over said device; and
a flexible membrane that covers said opening and is attached to said touchscreen cover.

2. The protective cover of claim 1 further comprising a rigid polycarbonate plastic frame onto which said touch screen cover is attached.

3. The protective cover of claim 1 wherein said touchscreen cover further comprises Polyethylene terephthalate.

4. The protective cover of claim 1 wherein said flexible membrane further comprises Thermoplastic polyurethane.

5. The protective cover of claim 1 wherein said flexible membrane is bonded to said touchscreen cover.
